(19) United States
(12) Patent Application Publication
(10) Pub. No.: US 2009/0132597 A1
(43) Pub. Date: May 21, 2009

(54) IMAGE EDITING APPARATUS AND IMAGE EDITING METHOD

(75) Inventor: Shinji KAWASAKI, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA MACHINERY LTD., Kyoto-shi (JP)

(21) Appl. No.: 12/265,148

(22) Filed: Nov. 5, 2008

(30) Foreign Application Priority Data
Nov. 19, 2007 (JP) 2007-299127
Nov. 21, 2007 (JP) 2007-301325

(51) Int. Cl. G06F 17/30

(52) U.S. Cl. 707/104.1; 707/E17.009

(57) ABSTRACT

A destination information management unit manages filtering permission information that indicates whether or not to perform filter settings with respect to each index recorded in index data, in association with destination information or distribution destination information in which a distribution destination of a printed document on which document image data is printed. A filter setting unit creates filter setting data based on the filtering permission information and the index data. The filter setting data is information in which the filter-settings-permitted index is associated with a filter pattern. By using a setting interface displayed on a monitor, a user performs the filter settings of the document image data with respect to each transmission destination or distribution destination. After being edited, the document image data is transmitted via facsimile to each transmission destination, or is printed.

### CROSS-REFERENCE TO RELATED APPLICATIONS

This application claims priority under 35 U.S.C. 119 to Japanese Patent Application No. 2007-299127, filed on Nov. 19, 2007, and Japanese Patent Application No. 2007-301325, filed on Nov. 21, 2007, the entire contents of these applications are herein incorporated by reference in their entirety.

### BACKGROUND

1. Field

An aspect of the invention relates to an image editing apparatus and an image editing method that perform a filtering process on image data.

2. Description

A document management system that manages in-house documents and/or external documents is being increasingly used in businesses. The document management system manages not only electronic data such as electronic mails (e-mails) and web pages, but also image data that is generated by scanning paper-based documents using a scanner. The data managed by the document management system includes substantial pieces of confidential information, such as individual information (i.e., personal data), technical information, and monetary information.

When image data that includes confidential information is output as it is by printing or facsimile transmission, the confidential information could be leaked to the outside. In order to prevent the confidential information from being leaked to the outside, a filling process is performed in which an area displaying the confidential information of the image data is filled with black before the image data is output.

Further, some image data is output in a state where important information displayed in the image data is highlighted. In such a case, a highlighting process is performed in which an area displaying the important information is framed or shaded.

For example, an image editing apparatus that performs the filling process and the highlighting process (hereinafter, referred to as a “filtering process”) on image data has been disclosed.

In response to user operations, the above-described image editing apparatus provides, to original document image data, a masking object arranged to specify an area on which the filtering process will be performed. Then, masking object template data including various pieces of data, such as position information of the masking object, is created and registered in template management data. In the conventional image editing apparatus, the masking object template data is inserted into an extension header portion of the original document image data, and edited original document image data is created.

As described above, the conventional image editing apparatus registers, in the template management data, the masking object template data that specifies the area on which the filtering process will be performed. Now, an example will be described in which the filtering process is performed on another image data of a format that is identical to that of the original document image data. In such a case, by using the masking object template data registered in the template management data, a user specifies the area on which the filtering process will be performed. Thus, the user can eliminate the trouble of specifying the area on which the filtering process will be performed.

However, after specifying the area on which the filtering process will be performed, the user needs to specify a display state with respect to each area on which the filtering process will be performed. For example, when transmitting, via facsimile, image data in which a plurality of areas arranged for the filtering process is specified, the user needs to set the display state such as a filling display and a highlighting display with respect to each specified area in accordance with a facsimile transmission destination. Moreover, in the case of a plurality of facsimile transmission destinations, the area that requires the filling display and the like differs depending on each destination.

Accordingly, in the conventional image editing apparatus, in accordance with the transmission destination of the image data, settings of the display state are required with respect to each area on which the filtering process will be performed, thereby making the user operations cumbersome.

Further, when there is a plurality of distribution destinations of a printed paper on which the image data is printed, in some cases, the user may change the display state of the specified area with respect to each distribution destination. In the conventional image editing apparatus, when changing the settings of the display state with respect to each distribution destination, the user needs to repeat the settings of the display state of each specified area, and an instruction for printing. In other words, the conventional image editing apparatus has problems in that the user operations required for the filter process are cumbersome.

### SUMMARY

In order to overcome the problems described above, embodiments of the present invention provide an image editing apparatus and an image editing method in which a user can easily perform a filtering process on image data.

In order to overcome the problems described above, according to an aspect of the present invention, an image editing apparatus that edits image data to be transmitted to a transmission destination includes: a storage unit arranged to store, along with the image data, index data in which a character string extracted from the image data and area information indicating an area that includes the character string are recorded as an index of the image data; a management unit arranged to manage, in association with transmission destination information, determination information that is used to determine whether or not to apply filtering to the index; a filter setting unit arranged to set filter setting information with respect to the filtering-permitted index; and an image editing unit arranged to edit the image data based on the area information and the filter setting information.

In the image editing apparatus according to another aspect of the present invention, the index records the character string and the area information in association with an identifier of the index, and the determination information is information in which the identifier is associated with information indicating whether or not to apply filtering.

In the image editing apparatus according to another aspect of the present invention, the filter setting information includes information regarding filter patterns to be applied to the index.

According to another aspect of the present invention, an image editing apparatus that edits the image data to be printed includes: a storage unit arranged to store, along with image data, index data in which a character string extracted from the image data and area information indicating an area that includes the character string are recorded as an index of the image data; a management unit arranged to manage, in association with distribution destination information of a printed document on which the image data is printed, determination information that is used to determine whether or not to apply filtering to the index; a filter setting unit arranged to set filter setting information with respect to the filtering-permitted index; and an image editing unit arranged to edit the image data based on the area information and the filter setting information.

In the image editing apparatus according to another aspect of the present invention, the index records the character string and the area information in association with an identifier of the index, and the determination information is information in which the identifier is associated with information indicating whether or not to apply filtering.

In the image editing apparatus according to another aspect of the present invention, the filter setting information includes information regarding filter patterns to be applied to the index.

According to the above-described aspect of the present invention, the image editing apparatus determines, in accordance with the transmission destination of the image data, whether or not to apply the filtering to the index that includes the area information of the image data. Therefore, a user can perform a filtering process of the image data by setting a display state on the area associated with the transmission destination. Accordingly, the image editing apparatus can simplify user operations performed in the filtering process of the image data.

According to the above-described aspect of the present invention, the image editing apparatus determines, in accordance with the distribution destination of the printed document on which the image data is printed, whether or not to apply the filtering to the index that includes the area information of the image data. Therefore, a user can perform a filtering process of the image data by setting a display state on the area associated with the distribution destination of the printed document. Accordingly, the image editing apparatus of the present invention can simplify user operations performed in the filtering process of the image data.

Other features, elements, processes, steps, characteristics and advantages of the present invention will become more apparent from the following detailed description of embodiments of the present invention with reference to the attached drawings.

### BRIEF DESCRIPTION OF THE DRAWINGS

FIG. 1 is a block diagram of a document management system including a configuration of a network Multi Function Peripheral (MFP) according to an embodiment of the present invention.

FIG. 2 is an example of document image data.

FIG. 3 illustrates index data created based on the document image data of FIG. 2.

FIG. 4 is an example of destination information.

FIG. 5 is an example of filter setting data.

FIG. 6 is a flowchart illustrating operations of the network MFP performed when transmitting the document image data via facsimile.

FIG. 7 is an example of a setting interface in an initial state.

FIG. 8 is an example of the setting interface in which filter settings have been changed.

FIG. 9 is a block diagram of a document management system including a configuration of a network MFP according to another embodiment of the present invention.

FIG. 10 is an example of document image data.

FIG. 11 illustrates index data created based on the document image data of FIG. 10.

FIG. 12 is an example of distribution destination information.

FIG. 13 is an example of filter setting data.

FIG. 14 is a flowchart illustrating operations of the network MFP performed when printing the document image data.

FIG. 15 is an example of a setting interface in an initial state.

FIG. 16 is an example of the setting interface in which filter settings have been changed.

### DETAILED DESCRIPTION OF PREFERRED EMBODIMENTS

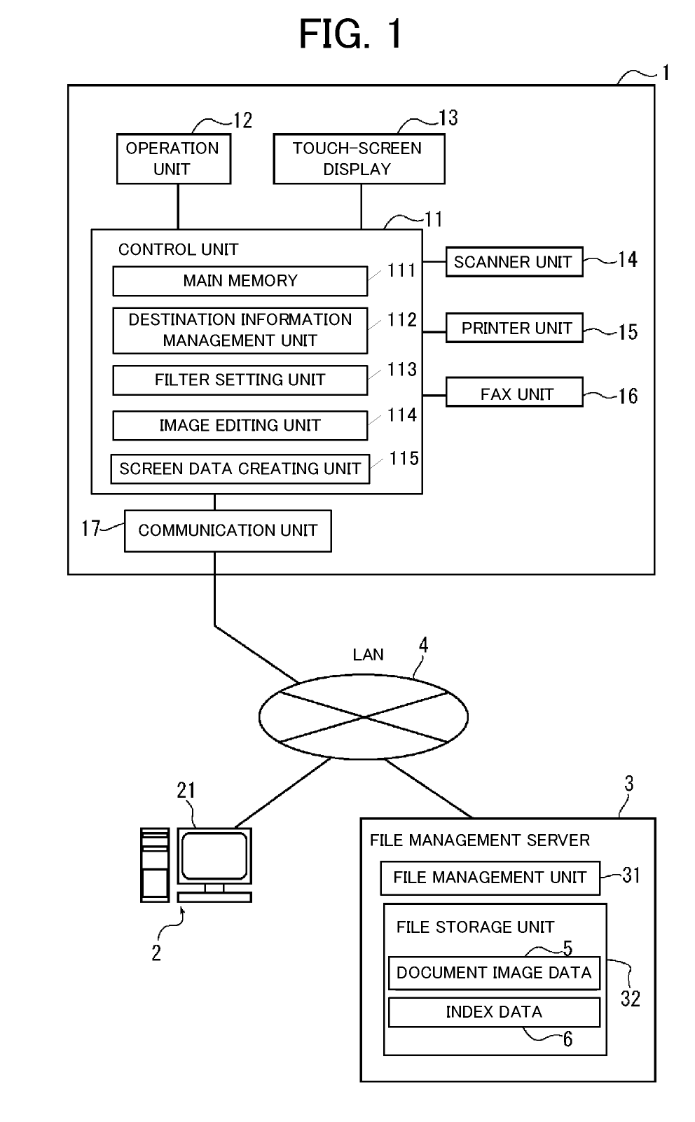

With reference to the drawings, an embodiment of the present invention will be described. A network MFP will be described as an example of an image editing apparatus of an embodiment of the present invention. FIG. 1 is a block diagram of a document management system including a configuration of the network MFP according to one embodiment of the present invention.

In a document management system of FIG. 1, a network MFP 1, a personal computer (PC) 2, and a file management server 3 are connected with a Local Area Network (LAN) 4. The LAN 4 preferably includes a router (not illustrated) arranged to connect with the Internet, other LANs, or the like.

The network MFP 1 is a multi functional apparatus that preferably includes a copier function, a printer function, a scanner function, a FAX function, and an electronic mail (e-mail) function, or the like. By directly operating the network MFP 1, a user can output document image data 5 managed by the file management server 3, in various formats such as printing, facsimile transmission, and e-mail transmission. Moreover, by operating the PC 2 connected with the LAN 4, the user can output the document image data 5.

The document image data 5 output from the network MFP 1 of FIG. 1 and index data 6 will be described.

The document image data 5 is electronic data that is created by scanning a paper-based document by a scanner. The index data 6 is data that is created with respect to each document image data 5, and that records an index used to search for each document image data 5. The index data 6 is described by using an Extensible Markup Language (XML), or the like. The document image data 5 and the index data 6 are associated with each other by, for example, matching character strings other than the extension of a file name, and are managed in the file management server 3.

For example, the index data 6 is created in the following process. First, text data is created from the document image data 5 in an optical character recognizing process, or the like. Then, based on a pre-set attribution name of attribution data and extraction conditions of the attribution name, a character string extracted from the text data is set as the attribution data. An area that includes the character string extracted as the attribution data is specified as an index area. The attribution data and area information indicating the index area are associated with each other, and thus, the index data 6 is created.

Alternatively, the user may specify the area from which the character string of the document image data 5 is extracted. In such a case, the area specified by the user corresponds to the index area, and the character string extracted from the specified index area corresponds to the attribution data.

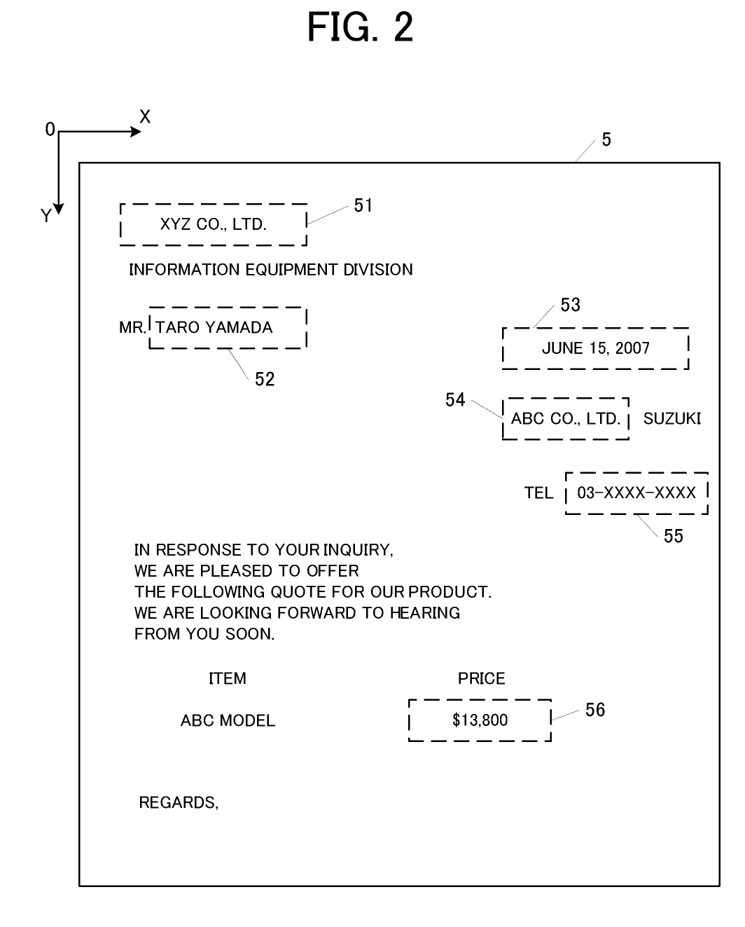

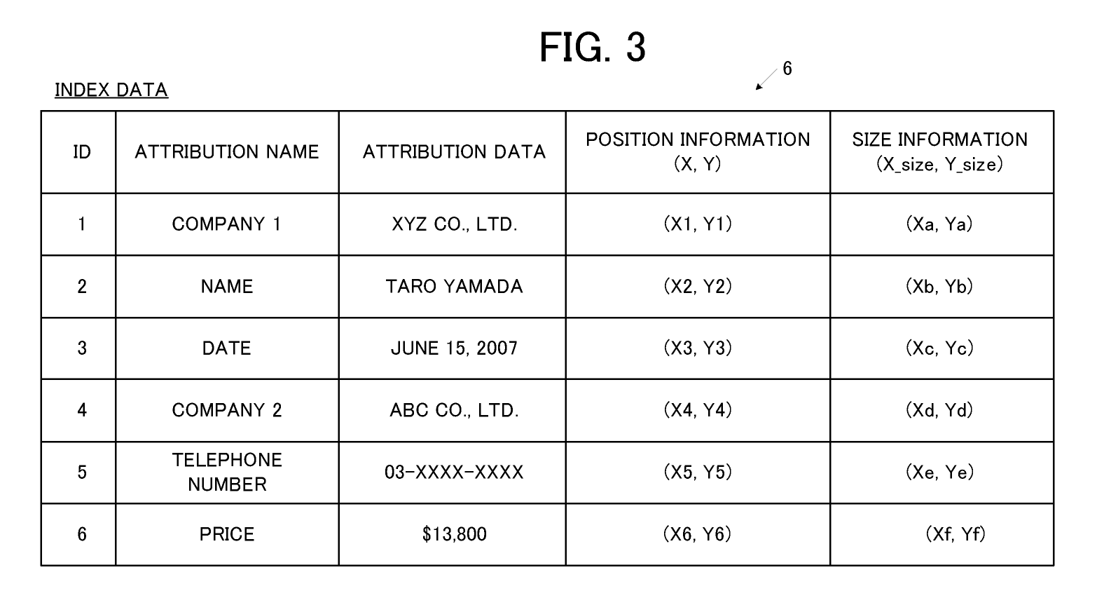

A specific example of the index data 6 will be described with reference to FIGS. 2 and 3. FIG. 2 is an example of the document image data 5. FIG. 3 illustrates the index data 6 in a table format, which is created based on the document image data 5 of FIG. 2.

In the document image data 5 of FIG. 2, areas surrounded by dashed lines are index areas 51 through 56. The index areas 51 through 56 display the character strings that are extracted as the attribution data from the document image data 5.

The index data 6 of FIG. 3 includes an ID, an attribution name, attribution data, position information, and size information. The ID is a number specifically allotted with respect to each character string extracted as the attribution data from the document image data 5. The attribution name is an item such as a “name” or an “address”. The attribution data corresponds to the attribution name, and is the character string that is included in each index area. More specifically, each attribution data of IDs 1 through 6 corresponds to the character string included in the respective index areas 51 through 56.

The position information and the size information are the area information that is used to specify the index areas 51 through 56. The position information indicates a position of the upper-left top of each index area. As illustrated in FIG. 2, assuming that the upper-left top of the document image data 5 is the origin, a rightward direction is an X-axis direction, and a downward direction is a Y-axis direction, the position information can be represented in an XY coordinate system. The size information indicates each length in the X-axis direction and in the Y-axis direction of each index area. Pixels are used as measurement units of the XY coordinate system. The index areas 51 through 56 preferably have a rectangular or a substantially rectangular shape in FIG. 2, but may have a circular shape, an oval shape, or any other desired shape, for example.

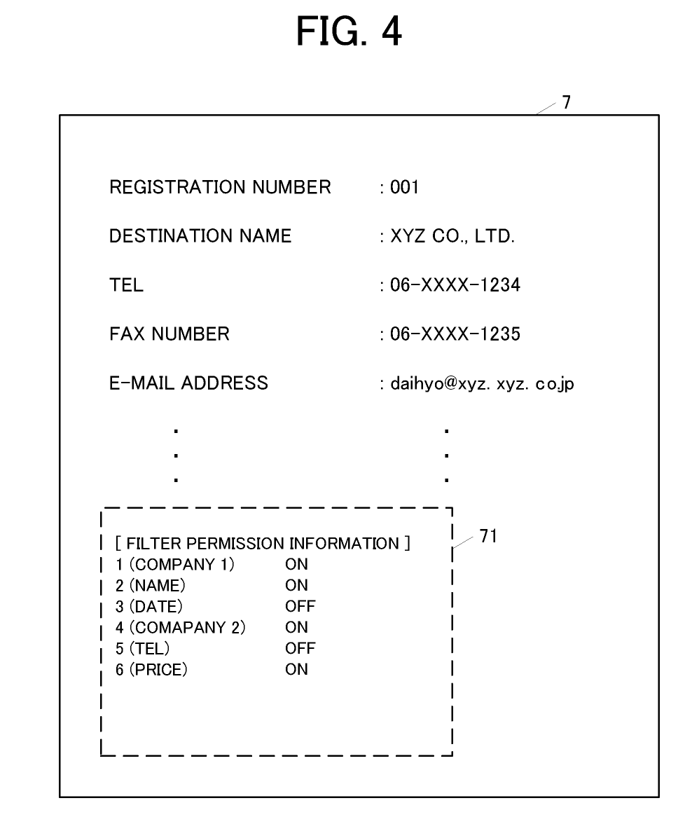

As illustrated in FIG. 2, in most cases, the character string extracted as the attribution data from the document image data 5 is confidential information such as an individual name, a company name, and monetary information. In other words, the index data 6 includes confidential information and information indicating an area that displays the confidential information. The above-described information may be important information. For example, an individual name and a company name are the important information from which a creation source of the document image data 5 can be specified. When transmitting the document image data 5 via facsimile, based on the index data 6 including the above-described features, and on filter permission information 71 (FIG. 4), the network MFP 1 specifies the area on which the filtering process will be performed. The filter permission information 71 will be described later in detail.

Next, a configuration of the network MFP 1 of FIG. 1 will be described. The network MFP 1 includes a control unit 11, an operation unit 12, a touch-screen display 13, a scanner unit 14, a printer unit 15, a FAX unit 16, and a communication unit 17.

The control unit 11 preferably includes a main memory 111, a destination information management unit 112, a filter setting unit 113, an image editing unit 114, a screen data creating unit 115, and a micro processor (not illustrated). The micro processor and the main memory 111 control the entire network MFP 1. Each function unit of the control unit 11 will be described later in detail.

The operation unit 12 preferably includes a hardware key arranged to enter various instructions to the network MFP 1, or the like. The touch-screen display 13 preferably displays information regarding the network MFP 1, and various operation menus. By using the operation unit 12 and the touch-screen display 13, the user can perform various operations of the network MFP 1.

The scanner unit 14 scans paper-based documents placed on an Auto Document Feeder (not illustrated), or the like, and outputs the scanned data as the document image data 5. The document image data 5 output by the scanner unit 14 is managed by the file management server 3 after the corresponding index data 6 is created.

The printer unit 15 prints data transmitted from the PC 2, or the like, on a recording paper in accordance with various setting conditions. The copier function of the network MFP 1 is implemented by cooperation of the control unit 11, the scanner unit 14, and the printer unit 15.

The FAX unit 16 performs facsimile communication via a Public Switched Telephone Network (PSTN, not illustrated). The communication unit 17 transmits to and/or receives from each computer connected with the LAN 4 or with the Internet, data by using a protocol such as a Transmission Control Protocol/Internet Protocol (TCP/IP).

Next, each function unit of the control unit 11 will be described. The main memory 111 includes a Random Access Memory (RAM), or the like, and stores the document image data 5 and index data 6 that are transmitted from the file management server 3 or the PC 2.

The destination information management unit 112 manages destination information 7 in which a telephone number, a facsimile number, and an e-mail address, etc. are recorded with respect to each registered destination name. FIG. 4 is an example of the destination information 7 managed in the destination information management unit 112.

In the destination information 7 of FIG. 4, a registration number is a unique number that is allotted to each destination name. The destination name is a character string that allows the user to identify a destination. Along with the telephone number, the facsimile number, and the e-mail address, the filter permission information 71 is also recorded in the destination information 7. The destination information 7 is registered by the user.

The filter permission information 71 is used along with the index data 6 when specifying the area on which the filtering process will be performed with respect to the document image data 5. The filter permission information 71 is set with respect to each destination name, and records whether or not filter settings will be performed with respect to each attribution name registered in the index data 6. A numeric value on a left side of each attribution name is an identification number of each attribution name.

In the index permission information 71, for example, the attribution name “NAME” is set to “ON”, indicating that filter settings can be performed on the index area 52, which corresponds to the attribution name “NAME”. The attribution name “DATE” is set to “OFF”, indicating that filter settings cannot be performed on the index area 53, which corresponds to the attribution name “DATE”. In other words, the filter permission information 71 is the information that sets, with respect to each index, whether or not a filtering can be performed on the index recorded in the index data 6.

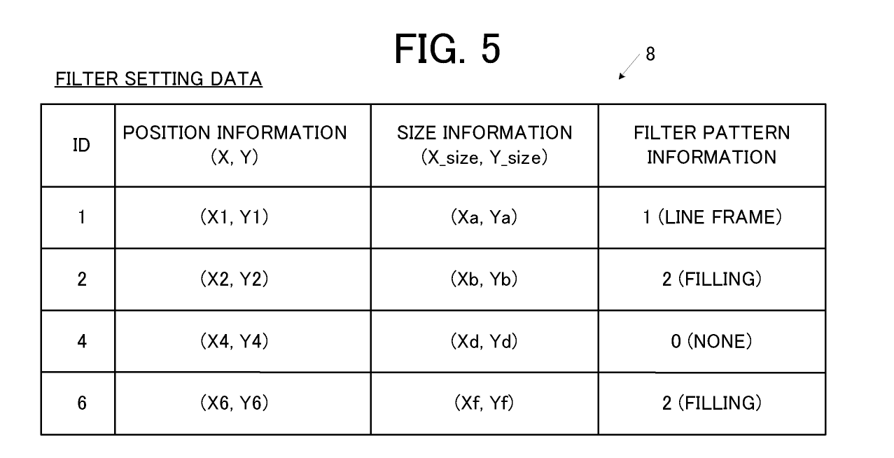

The filter setting unit 113 uses the index data 6 and the filter permission information 71 in order to create filter setting data 8 (FIG. 5). Information indicating the area on which the filtering process will be performed and filter patterns that indicate a display state of each area are recorded in the filter setting data 8.

The image editing unit 114 edits the document image data 5 based on the filter setting data 8, and creates output data.

The screen data creating unit 115 creates screen data in order to display, on a monitor 21 of the PC 2, a user interface (hereinafter, referred to as a “setting interface”) arranged to perform the filter settings and the like of the document image data 5. The screen data is created based on the document image data 5, the index data 6, and the filter setting data 8.

Next, the file management server 3 will be described. The file management server 3 preferably includes a file management unit 31 and a file storage unit 32. In response to a request from each computer connected with the LAN 4, the file management unit 31 transmits the document image data 5 and the index data 6, or searches for the document image data 5, or the like. The file storage unit 32 preferably includes a hard disc device etc., and stores the document image data 5 and the index data 6.

Now, the filter setting data 8 will be described in detail. FIG. 5 illustrates the filter setting data 8 created based on the index data 6 and the filter permission information 71.

In the filter setting data 8 of FIG. 5, IDs are the IDs that correspond to the attribution names for which the filter settings are permitted in the filter permission information 71 and that are extracted from the IDs recorded in the index data 6. In the filter permission information 71, the filter-settings-permitted attribution names are “COMPANY 1”, “NAME”, “COMPANY 2”, and “PRICE”. Accordingly, from the IDs recorded in the index data 6, the ID 1, ID 2, ID 4 and ID 6 are recorded as the IDs of the filter setting data 8.

Position information and size information are the position information and the size information that correspond to the IDs extracted from the index data 6, and that indicate the areas on which the filtering process will be performed with respect to the document image data 5.

Filter pattern information is numeric information that indicates a filter pattern of the area on which the filtering process will be performed. As illustrated in FIG. 5, any one of the numeric values “0”, “1”, or “2” is set to the filter pattern information. The filter pattern information “0” indicates that a filtering process will not be performed. The filter pattern information “1” indicates that a highlighting process in which the area arranged for the filtering process is surrounded by a line frame will be performed. The filter pattern information “2” indicates that a filling process will be performed on the area arranged for the filtering process.

In FIG. 5, the filter pattern information of the ID 1 indicates “1”. In this case, a highlighting display is performed on the index area 51. The filter pattern information of the ID 2 and ID 6 indicates “2”. In this case, a filling display is performed on the index areas 52 and 56. The filter pattern information of the ID 4 indicates “0”. In this case, the filtering process will not be performed on the index area 54.

The ID 3 and ID 5 are not recorded in the filter setting data 8. Therefore, a filter pattern cannot be set with respect to the index areas 53 and 55, which correspond to the ID 3 and ID 5.

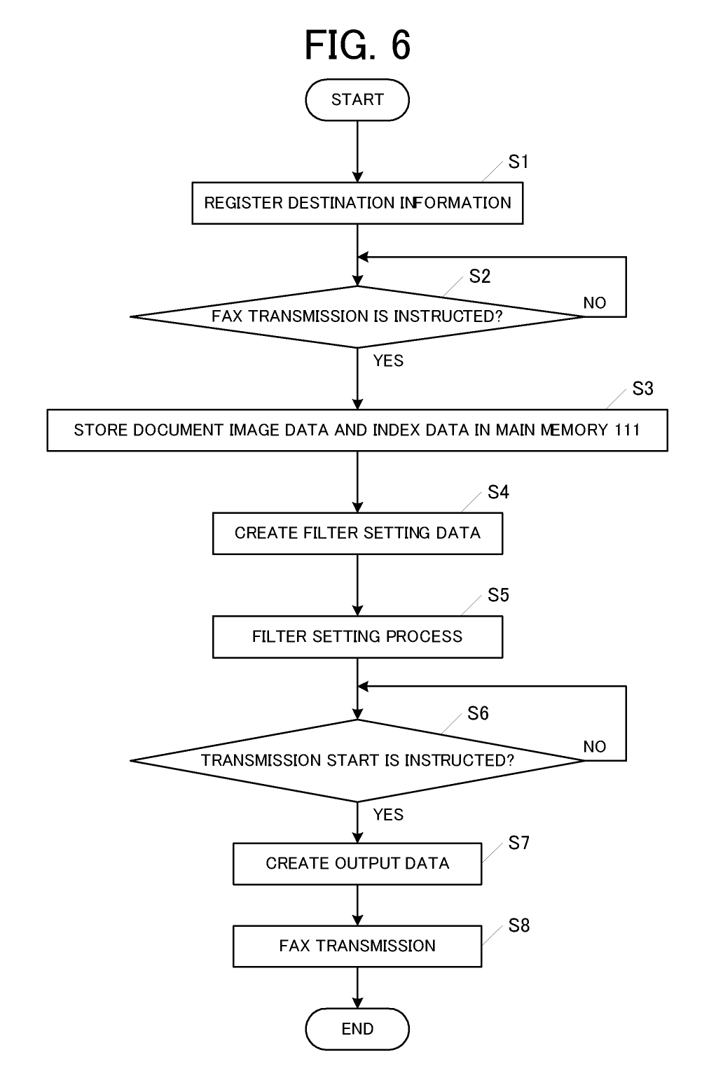

With reference to FIG. 6, operations performed when the network MFP 1 having the above-described configuration outputs the document image data 5 will be described. FIG. 6 is a flowchart illustrating the operations in which the network MFP 1 transmits the document image data 5 via facsimile.

First, the user creates the destination information 7 by operating the PC 2. The destination information 7 created by the user is registered in the destination information management unit 112 (step S1). Alternatively, the user may create the destination information 7 by operating the operation unit 12 and the touch-screen display 13.

Then, the user operates the PC 2 in order to instruct the network MFP 1 for facsimile transmission. A destination name of a transmission destination, a file name of the document image data 5, and a file name of the index data 6 are transmitted as the instruction for the facsimile transmission from the PC 2 to the network MFP 1. It is assumed that the user specifies a plurality of destination names as the transmission destinations for the facsimile transmission.

When the instruction for the facsimile transmission is received (“Yes” in step S2), the network MFP 1 accesses the file management server 3 in order to acquire the document image data 5 and index data 6. The network MFP 1 stores the acquired document image data 5 and index data 6 in the main memory 111 (step S3). When the file name of the index data 6 is specified, the network MFP 1 determines that it is necessary to perform a filtering process on the document image data 5.

The filter setting unit 113 creates the filter setting data 8 that corresponds to each transmission destination by using the index data 6 and the filter permission information 71 (step S4). In the filter setting data 8 created based on the instruction for the facsimile transmission, the filter pattern information of each ID indicates “0”.

Then, the network MFP 1 performs a filter setting process on the document image data 5 with respect to each transmission destination (step S5). The filter setting process will be described later in detail.

After the filter setting process, the user instructs the network MFP 1 for the facsimile transmission. In response to the instruction for facsimile transmission start (“Yes” in step S6), the image editing unit 114 edits the document image data 5 based on the filter setting data 8 that corresponds to each transmission destination, and creates output data (step S7). At this time, a copy of the document image data 5 is edited, and thus, the output data corresponding to each transmission destination is created.

The FAX unit 16 transmits the output data via facsimile to each transmission destination (step S8). Thus, the facsimile transmission process of the document image data 5 is completed.

Next, operations of the network MFP 1 performed at the time of filter setting process (step S5) will be described.

First, based on the filter setting data 8 of each transmission destination, the screen data creating unit 115 creates screen data that corresponds to each transmission destination specified by the user. Any one of the created screen data is transmitted to the PC 2. The PC 2 receives the screen data and displays the setting interface on the monitor 21. By using the setting interface, the user performs filter settings of the document image data 5 with respect to each transmission destination.

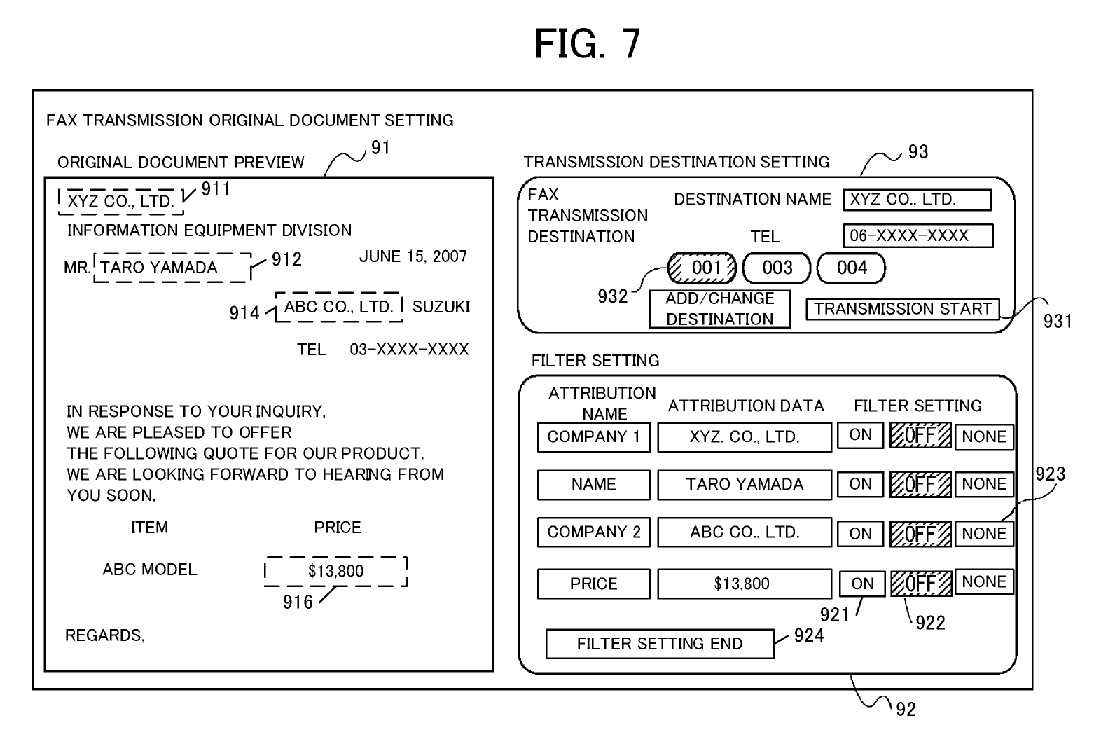

Now, the setting interface will be described in detail. FIG. 7 illustrates the setting interface in an initial state used to perform the filter settings of the document image data 5. For illustration purposes, in FIG. 7, a shading display is used in place of a solid black display.

As illustrated in FIG. 7, the setting interface includes an original document preview portion 91, a filter setting display portion 92, and a transmission destination setting portion 93.

The original document preview portion 91 displays a preview of the document image data 5 edited based on the filter setting data 8. In the original document preview portion 91, filter areas 911, 912, 914, and 916 indicating the areas on which the filtering process will be performed are displayed in dashed-lines. The filter areas 911, 912, 914, and 916 respectively correspond to the index areas 51, 52, 54, and 56. The filter areas are not displayed for the areas that correspond to the index areas 53 and 55. That is because the attribution names “DATE” and “TELEPHONE NUMBER” are set to “OFF” in the filter permission information 71.

The filter setting display portion 92 displays the attribution name and attribution data that correspond to each filter area. A filter validating button 921, a filter invalidating button 922, and a filter selection menu 923 are provided with respect to each displayed attribution data.

The filter validating button 921 is a button that validates the filter settings of the corresponding filter area. When the filter settings are valid, the filter validating button 921 is displayed in black, and the filter selection menu 923 becomes usable. The filter invalidating button 922 is a button that invalidates the filter settings of the corresponding filter area. When the filter settings are invalid, the filter invalidating button 922 is displayed in black, and the filtering process is not performed on the corresponding filter area. In the initial state, all of the filter invalidating buttons 922 are displayed in black. That is because, when the screen data is created, all of the filter pattern information of the filter setting data 8 indicates “0”.

The filter selection menu 923 displays, in a pull-down format, filter patterns that can be set on each filter area. The filter pattern set on each filter area is displayed in each title of the filter selection menu 923.

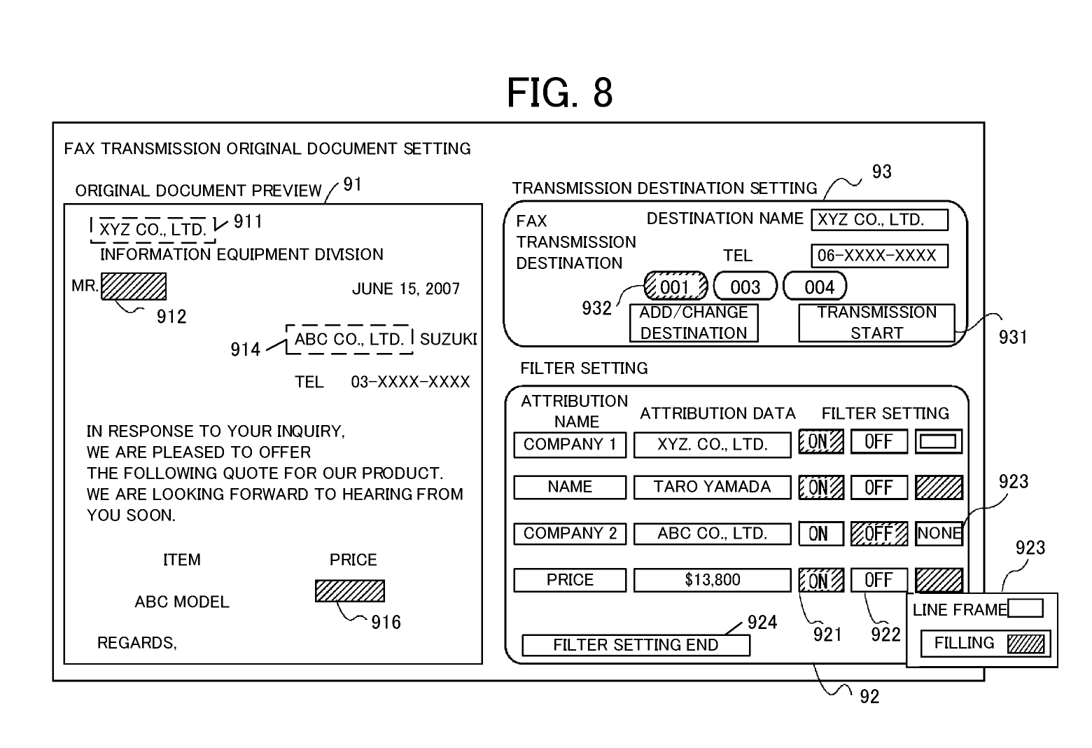

The filter patterns that can be set on each filter area are shown in the filter selection menu 923 that corresponds to the attribution data “$13,800” of FIG. 8. The filter patterns that can be set on each filter area are “LINE FRAME” and “FILLING”. The filter patterns “LINE FRAME” and “FILLING” respectively correspond to the filter pattern information “1” and “2” that are recorded in the filter setting data 8. A detailed description of FIG. 8 will be made later.

A filter setting end button 924 is arranged to notify the network MFP 1 of the completion of filter settings regarding the transmission destination displayed on the setting interface.

The transmission destination setting portion 93 displays information regarding the facsimile transmission destination, a transmission start button 931, and screen selection buttons 932. The transmission destination setting portion 93 may display buttons used to set whether or not to attach a cover letter, and to set whether or not to confirm receptions.

The screen selection buttons 932 are the buttons arranged to call up the setting interface that corresponds to each transmission destination. Numeric values displayed on the screen selection buttons 932 are the registration numbers of the destination information 7.

Now, the description of the operations of the network MFP 1 performed at the time of filter setting process is made again. The user presses the filter validating button 921 that corresponds to the filter area for which the filter settings are changed. By using the filter selection menu 923, the user sets the filter pattern of the filter area for which the filter settings have been validated.

The PC 2 transmits, to the network MFP 1, the ID and filter pattern information that correspond to the filter area for which the filter settings have been changed. The filter setting unit 113 updates the filter setting data 8 based on the received ID and filter pattern information. The screen data creating unit 115 creates screen data based on the updated filter setting data 8, and transmits the created screen data to the PC 2. Thus, the setting interface reflecting (displaying) the change of the filter settings is displayed on the monitor 21 of the PC 2. The user repeats the above-described operation with respect to the setting interface, and performs the filter settings of the document image data 5 that corresponds to each transmission destination.

When performing the filter settings of the document image data 5 with respect to another transmission destination, the user presses the filter setting end button 924. In response to the instruction for the filter setting completion, the screen data creating unit 115 transmits screen data of the transmission destination for which the filter settings have not been completed. When the filter settings of the document image data 5 with respect to all of the transmission destinations are completed, the network MFP 1 completes the filter setting process. The user may call up the setting interface that corresponds to each transmission destination by pressing the screen selection button 932.

The screen data creating unit 115 creates the original document preview portion 91 without directly editing the document image data 5. For example, the screen data creating unit 115 can create the original document preview portion 91 by overlapping a rectangular graphical object having a black displaying color on the document image data 5.

FIG. 8 illustrates the setting interface displayed after the filter settings of the document image data 5 are changed. The reference numerals of FIG. 8 correspond to those of FIG. 7. For illustration purposes, FIG. 8 uses a shading display in place of a solid black display. In FIG. 8, the filter pattern displayed in each title of the filter selection menu 923 corresponds to a display state of each of the filter areas 911, 912, 914, and 916.

As described above, when transmitting the document image data 5 via facsimile, the network MFP 1 according to the present preferred embodiment sets, with respect to each transmission destination, the areas on which the filtering process will be performed, based on the index data 6 and the filter permission information 71. Accordingly, the user can perform the filtering process of the document image data 5 only by setting the display states of the index areas that are associated with the transmission destinations.

An example in which the network MFP 1 transmits the document image data 5 via facsimile has been described, however, the present invention is not limited to the above-described example. For example, when transmitting the document image data 5 via e-mail, the above-described processes may be applied. In such a case, the displays of the transmission destination setting portion 93 illustrated in FIGS. 7 and 8 may be replaced with an interface arranged for e-mail transmission.

An example in which the user operates the PC 2 in order to transmit the document image data 5 via facsimile has been described, however, the present invention is not limited to the above-described example. The user may directly operate the network MFP 1 to perform the filter settings of the document image data 5. In such a case, the setting interface illustrated in FIGS. 7 and 8 is displayed on the touch-screen display 13.

An example in which the network MFP 1 acquires, from the file management server 3, the document image data 5 and the index data 6 for facsimile transmission, however, is not limited to the above-described example. For example, the PC 2 may store the document image data 5 and the index data 6. In such a case, when the user 2 instructs the network MFP 1 for facsimile transmission by using the PC 2, the document image data 5 and the index data 6 are transmitted from the PC 2 to the network MFP 1.

An example of the highlighting process using line frames and the filling process using black color has been described, however, the present invention is not limited to the above-described example. For example, the display color may be inverted in the highlighting process. In the filling process, colors other than black may be used.

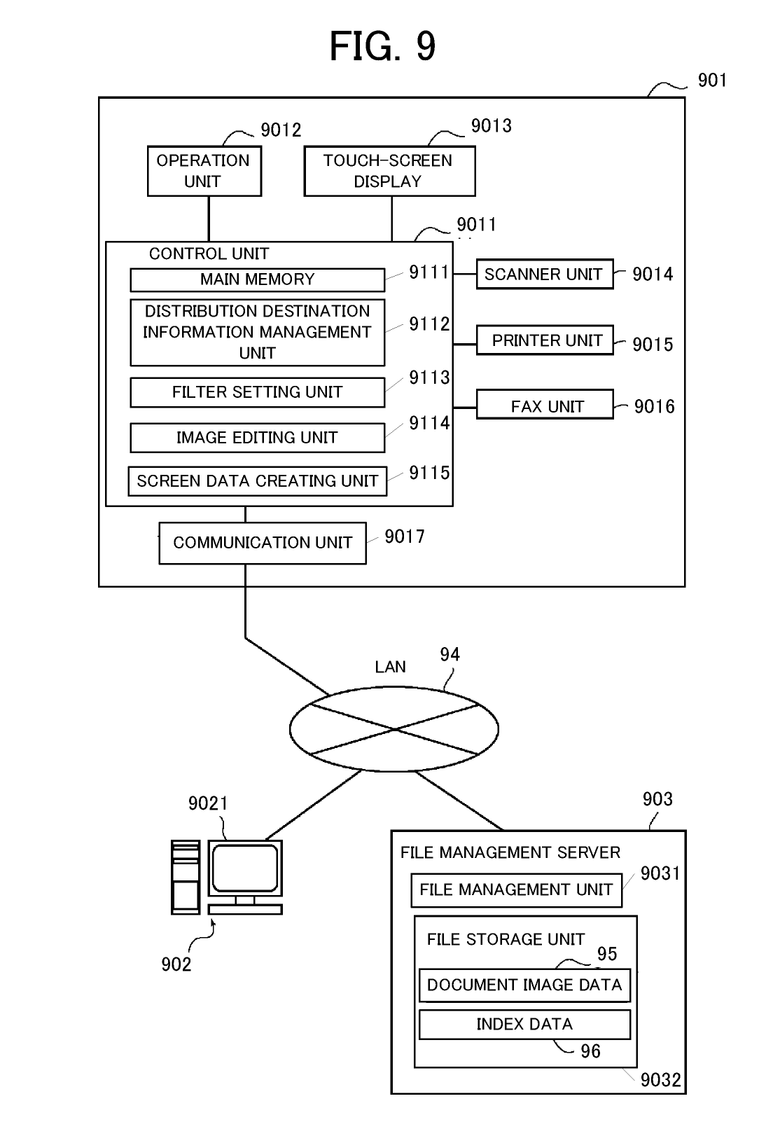

With reference to the drawings, another embodiment of the present invention will be described. Here, a network MFP will be described as an example of an image editing apparatus according to a preferred embodiment of the present invention. FIG. 9 is a block diagram of a document management system including a configuration of the network MFP according to the preferred embodiment.

In a document management system of FIG. 9, a network MFP 901, a PC 902, and a file management server 903 are connected with a LAN 94. The LAN 94 preferably includes a router (not illustrated) arranged to connect with the Internet, other LANs, or the like.

The network MFP 901 is a multi functional apparatus that preferably includes a copier function, a printer function, a scanner function, a FAX function, and an e-mail function, or the like. By directly operating the network MFP 901, the user can output document image data 95 managed by the file management server 903, in various formats such as printing, facsimile transmission, and e-mail transmission. Moreover, by operating the PC 902 connected with the LAN 94, the user can output the document image data 95.

The document image data 95 output from the network MFP 901 of FIG. 9 and index data 96 will be described.

The document image data 95 is electronic data that is created by scanning a paper-based document by a scanner. The index data 96 is created with respect to each document image data 95, and records an index used to search for each document image data 95. The index data 96 is described by using the XML, or the like. The document image data 95 and the index data 96 are associated with each other by, for example, matching character strings other than the extension of a file name, and are managed in the file management server 903.

For example, the index data 96 is created in the following process. First, text data is created from the document image data 95 in an optical character recognizing process, or the like. Then, based on a pre-set attribution name of attribution data and extraction conditions of the attribution name, a character string extracted from the text data is set as the attribution data. An area that includes the character string extracted as the attribution data is specified as an index area. The attribution data and area information indicating the index area are associated with each other, and thus, the index data 96 is created.

Alternatively, the user may specify the area from which the character string of the document image data 95 is extracted. In such a case, the area specified by the user corresponds to the index area, and the character string extracted from the specified index area corresponds to the attribution data.

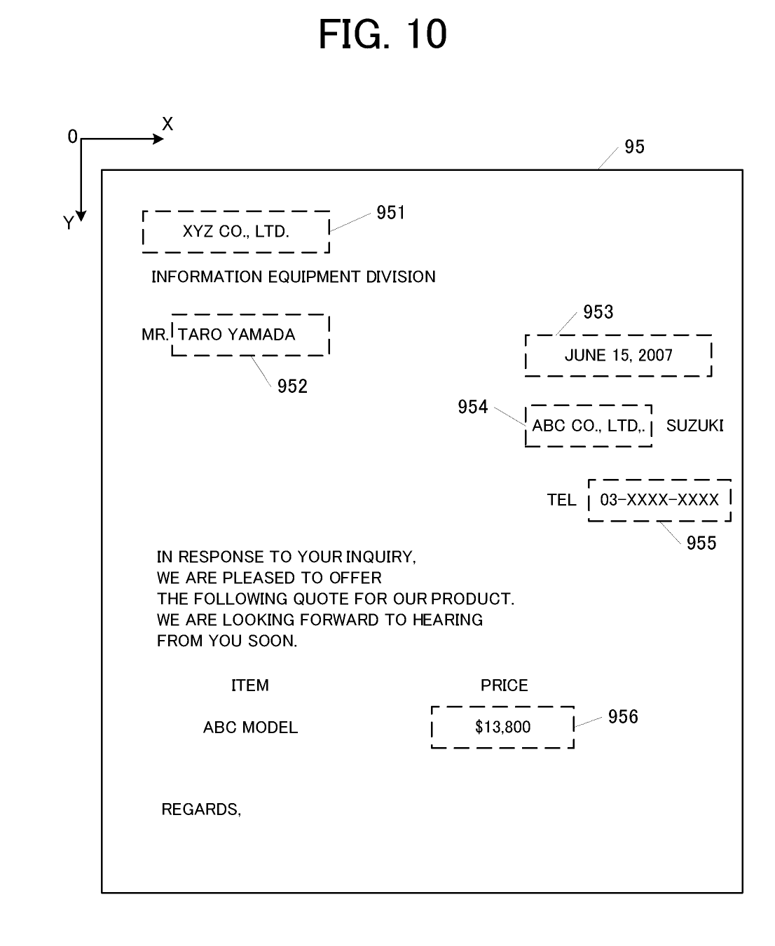

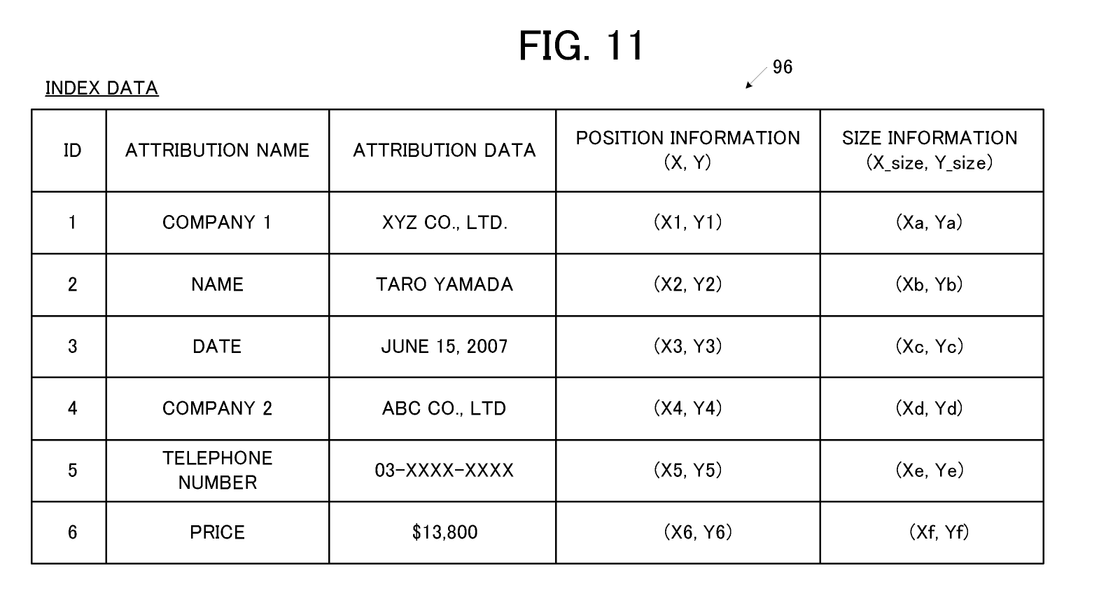

A specific example of the index data 96 will be described with reference to FIGS. 10 and 11. FIG. 10 is an example of the document image data 95. FIG. 11 illustrates the index data 96 in a table format, which is created based on the document image data 95 of FIG. 10.

In the document image data 95 of FIG. 10, areas surrounded by dashed lines are index areas 951 through 956. The index areas 951 through 956 display the character strings that are extracted as the attribution data from the document image data 95.

The index data 96 of FIG. 11 includes an ID, an attribution name, attribution data, position information, and size information. The ID is a number specifically allotted with respect to each character string extracted as the attribution data from the document image data 95. The attribution name is an item such as a “name” or an “address”. The attribution data corresponds to the attribution name, and is the character string that is included in each index area. More specifically, each attribution data of IDs 1 through 6 corresponds to the character string included in the respective index areas 951 through 956.

The position information and the size information are the area information that is used to specify the index areas 951 through 956. The position information indicates a position of the upper-left top of each index area. As illustrated in FIG. 10, assuming that the upper-left top of the document image data 95 is the origin, a rightward direction is an X-axis direction, and a downward direction is a Y-axis direction, the position information can be represented in an XY coordinate system. The size information indicates each length in the X-axis direction and in the Y-axis direction of each index area. Pixels are used as measurement units of the XY coordinate system. The index areas 951 through 956 have a rectangular or a substantially rectangular shape in FIG. 10, but may have a circular shape, an oval shape, or any other desired shape, for example.

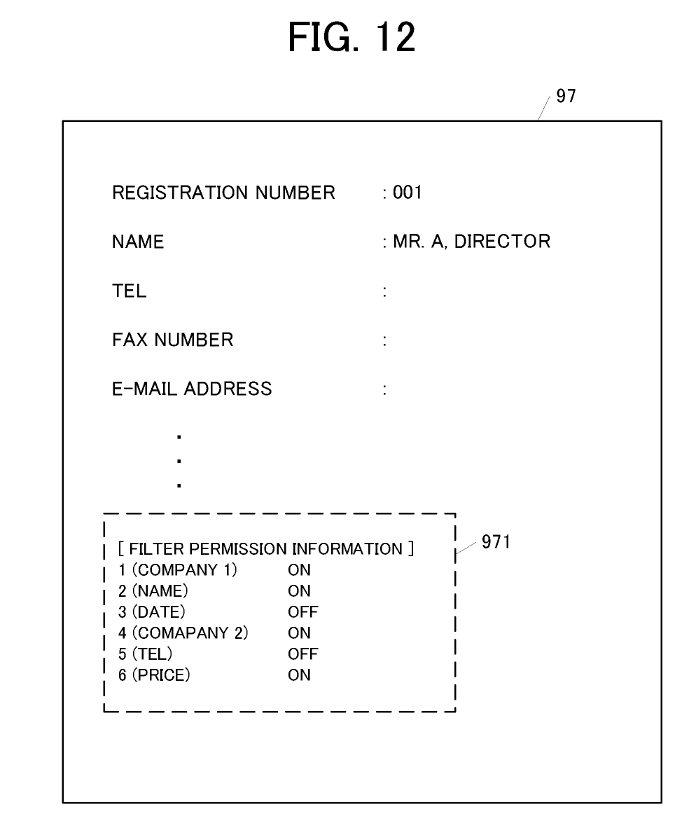

As illustrated in FIG. 10, in most cases, the character string extracted as the attribution data from the document image data 95 is confidential information such as an individual name, a company name, and monetary information. In other words, the index data 96 includes confidential information and information indicating an area that displays the confidential information. The above-described information may be important information. For example, an individual name and a company name are the important information from which a creation source of the document image data 95 can be specified. When printing the document image data 95, based on the index data 96 including the above-described features, and on filter permission information 971 (FIG. 12), the network MFP 901 specifies the area on which a filtering process will be performed. The filter permission information 971 will be described later in detail.

Next, a configuration of the network MFP 901 of FIG. 9 will be described. The network MFP 901 includes a control unit 9011, an operation unit 9012, a touch-screen display 9013, a scanner unit 9014, a printer unit 9015, a FAX unit 9016, and a communication unit 9017.

The control unit 9011 preferably includes a main memory 9111, a distribution destination information management unit 9112, a filter setting unit 9113, an image editing unit 9114, a screen data creating unit 9115, and a micro processor (not illustrated). The micro processor and the main memory 9111 control the entire network MFP 901. Each function unit of the control unit 9011 will be described later in detail.

The operation unit 9012 preferably includes a hardware key arranged to enter various instructions with respect to the network MFP 901, or the like. The touch-screen display 9013 preferably displays information regarding the network MFP 901, and various operation menus. By using the operation unit 9012 and the touch-screen display 9013, the user can perform various operations of the network MFP 901.

The scanner unit 9014 scans paper-based documents placed on an Auto Document Feeder (not illustrated), or the like, and outputs the scanned data as the document image data 95. The document image data 95 output by the scanner unit 9014 is managed by the file management server 903 after the corresponding index data 96 is created.

The printer unit 9015 prints data transmitted from the PC 902, or the like, on a recording paper in accordance with various setting conditions. The copier function of the network MFP 901 is implemented by cooperation of the control unit 9011, the scanner unit 9014, and the printer unit 9015.

The FAX unit 9016 performs facsimile communication via a PSTN (not illustrated). The communication unit 9017 transmits to and/or receives from each computer connected with the LAN 94 or with the Internet, data by using a protocol such as a TCP/IP.

Next, each function unit of the control unit 9011 will be described. The main memory 9111 includes a RAM, or the like, and stores the document image data 95 and index data 96 that are transmitted from the file management server 903 or the PC 902.

The distribution destination information management unit 9112 manages, in association with the filter permission information 971, distribution destination information 97 that indicates a distribution destination of the recording paper on which the document image data 95 is printed. FIG. 12 is an example of the distribution destination information 97 managed by the distribution destination information management unit 9112.

In the distribution destination information 97 of FIG. 12, a registration number indicates a unique number that is allotted to each distribution destination. A name indicates a character string that allows the user to identify the distribution destination. The filter permission information 971 is set with respect to each distribution destination. Data structure of the distribution destination information 97 of FIG. 12 is identical to data structure of telephone book data in which facsimile numbers and e-mail addresses can be recorded. A facsimile number and an e-mail address of each distribution destination may be recorded in the distribution destination information 97. The data structure of the distribution destination information 97 is not limited to the structure illustrated in FIG. 12.

The filter permission information 971 is used along with the index data 96 when specifying the area on which the filtering process will be performed with respect to the document image data 95. The filter permission information 971 records whether or not filter settings will be performed with respect to each attribution name registered in the index data 96. A numeric value on a left side of each attribution name is an identification number of each attribution name.

In the index permission information 971, for example, the attribution name “NAME” is set to “ON”, indicating that filter settings can be performed on the index area 952, which corresponds to the attribution name “NAME”. The attribution name “DATE” is set to “OFF”, indicating that filter settings cannot be performed on the index area 955, which corresponds to the attribution name “DATE”. In other words, the filter permission information 971 is the information that sets, with respect to each index, whether or not the filtering settings can be performed on the index recorded in the index data 96.

The filter setting unit 9113 uses the index data 96 and the filter permission information 971 in order to create filter setting data 98. Information indicating the area on which the filtering process will be performed and a filter pattern that indicates a display state of each area are recorded in the filter setting data 98.

The image editing unit 9114 edits the document image data 95 based on the filter setting data 98, and creates output data.

The screen data creating unit 9115 creates screen data arranged to display, on a monitor 921 of the PC 902, a user interface (hereinafter, referred to as a “setting interface”) arranged to perform the filter settings and the like of the document image data 95. The screen data is created based on the document image data 95, the index data 96, and the filter setting data 98.

Next, the file management server 903 will be described. The file management server 903 preferably includes a file management unit 9031 and a file storage unit 9032. In response to a request from each computer connected with the LAN 94, the file management unit 9031 transmits the document image data 95 and the index data 96, or searches for the document image data 95, or the like. The file storage unit 9032 preferably includes a hard disc device etc., and stores the document image data 95 and the index data 96.

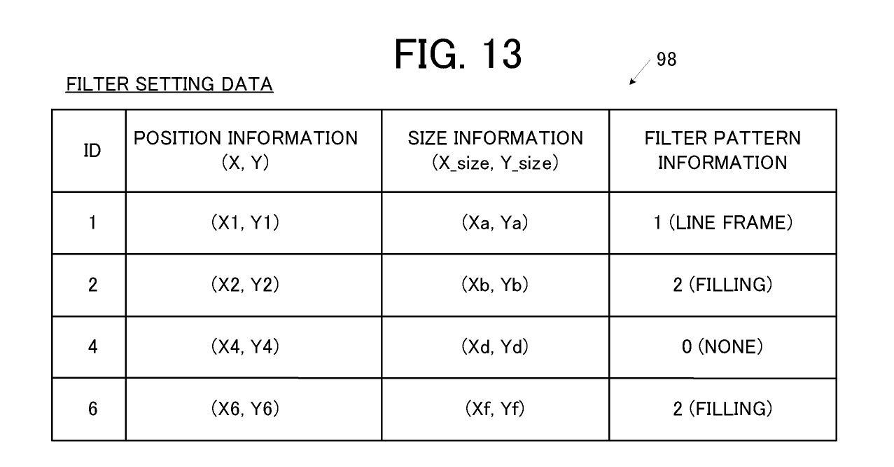

Now, the filter setting data 98 will be described in detail. FIG. 13 illustrates the filter setting data 98 created based on the index data 96 and the filter permission information 971.

In the filter setting data 98 of FIG. 13, IDs are the IDs that correspond to the attribution names for which the filter settings are permitted in the filter permission information 971 and that are extracted from the IDs recorded in the index data 96. In the filter permission information 971, the filter-settings-permitted attribution names are “COMPANY 1”, “NAME”, “COMPANY 2”, and “PRICE”. Accordingly, from the IDs recorded in the index data 96, the ID 1, ID 2, ID 4 and ID 6 are recorded as the IDs of the filter setting data 98.

Position information and size information are the position information and the size information that correspond to the IDs extracted from the index data 96, and that indicate the areas on which the filtering process will be performed with respect to the document image data 95.

Filter pattern information is numeric information that indicates a filter pattern of the area on which the filtering process will be performed. As illustrated in FIG. 13, any one of the numeric values “0”, “1”, or “2” is set to the filter pattern information. The filter pattern information “0” indicates that a filtering process will not be performed. The filter pattern information “1” indicates that a highlighting process in which the area arranged for the filtering process is surrounded by a line frame will be performed. The filter pattern information “2” indicates that a filling process will be performed on the area arranged for the filtering process.

In FIG. 13, the filter pattern information of the ID 1 indicates “1”. In this case, a highlighting display is performed on the index area 951. The filter pattern information of the ID 2 and ID 6 indicates “2”. In this case, a filling display is performed on the index areas 952 and 956. The filter pattern information of the ID 4 indicates “0”. In this case, the filtering process will not be performed on the index area 954.

The ID 3 and ID 5 are not recorded in the filter setting data 98. Therefore, a filter pattern cannot be set with respect to the index areas 953 and 955, which correspond to the ID 3 and ID 5.

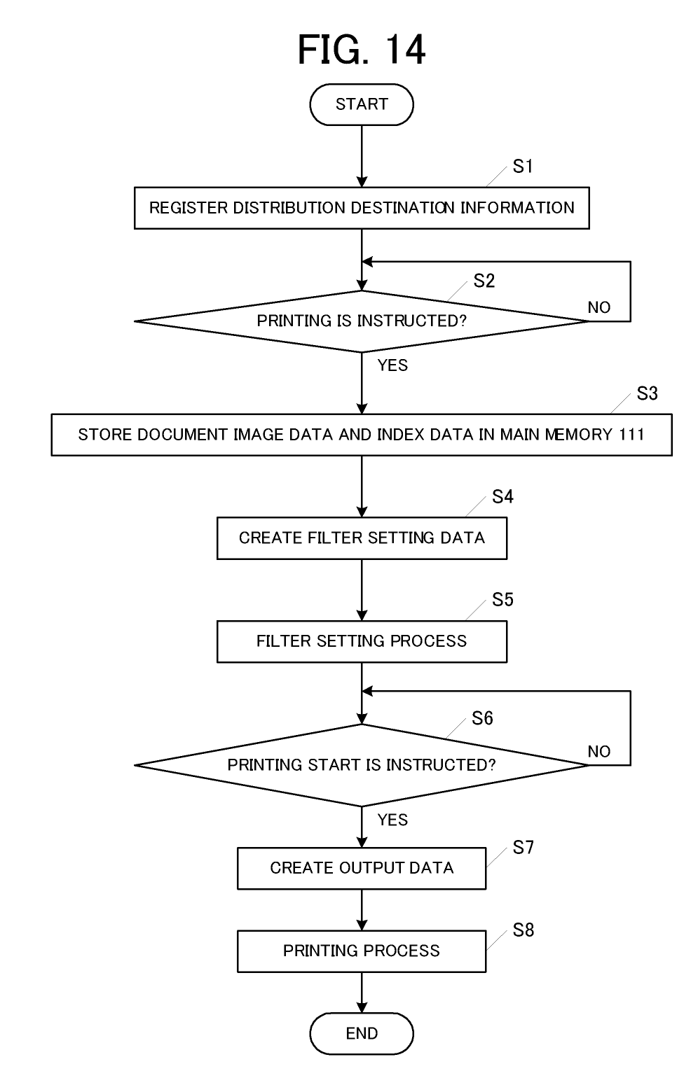

With reference to FIG. 14, operations performed when the network MFP 901 having the above-described configuration prints the document image data 95 will be described. FIG. 14 is a flowchart illustrating the operations in which the network MFP 901 prints the document image data 95.

First, the user creates the distribution destination information 97 by operating the PC 902. The distribution destination information 97 created by the user is registered in the distribution destination information management unit 9112 (step S1). Alternatively, the user may create the distribution destination information 97 by operating the operation unit 9012 and the touch-screen display 9013.

Then, the user operates the PC 902 in order to instruct the network MFP 901 to print the document image data 95. A distribution destination name, a file name of the document image data 95, and a file name of the index data 96 are transmitted as the instruction for printing from the PC 902 to the network MFP 901. It is assumed that the user specifies a plurality of distribution destinations.

When the instruction for printing is received (“Yes” in step S2), the network MFP 901 accesses the file management server 903 in order to acquire the document image data 95 and index data 96. The network MFP 901 stores the acquired document image data 95 and index data 96 in the main memory 9111 (step S3). When the file name of the index data 96 is specified, the network MFP 901 determines that it is necessary to perform a filtering process on the document image data 95.

The filter setting unit 9113 creates the filter setting data 98 that corresponds to each distribution destination by using the index data 96 and the filter permission information 971 (step S4). In the filter setting data 98 created based on the instruction for printing, the filter pattern information of each ID indicates “0”.

Then, the network MFP 901 performs a filter setting process on the document image data 95 with respect to each distribution destination (step S5). The filter setting process will be described later in detail.

After the filter setting process, the user instructs the network MFP 901 to start printing. In response to the instruction for printing-start (“Yes” in step S6), the image editing unit 9114 creates output data based on the filter setting data 98 that corresponds to each distribution destination (step S7). At this time, a copy of the document image data 95 is edited, and thus, the output data corresponding to each distribution destination is created. The printer unit 9015 prints the output data that corresponds to each distribution destination (step S8). Thus, the printing process of the document image data 95 is completed.

Next, operations of the network MFP 901 performed at the time of filter setting process (step S5) will be described.

First, based on the filter setting data 98 of each distribution destination, the screen data creating unit 9115 creates screen data that corresponds to each distribution destination specified by the user. Any one of the created screen data is transmitted to the PC 902. The PC 902 receives the screen data and displays the setting interface on a monitor 9021. By using the setting interface, the user performs filter settings of the document image data 95 with respect to each distribution destination.

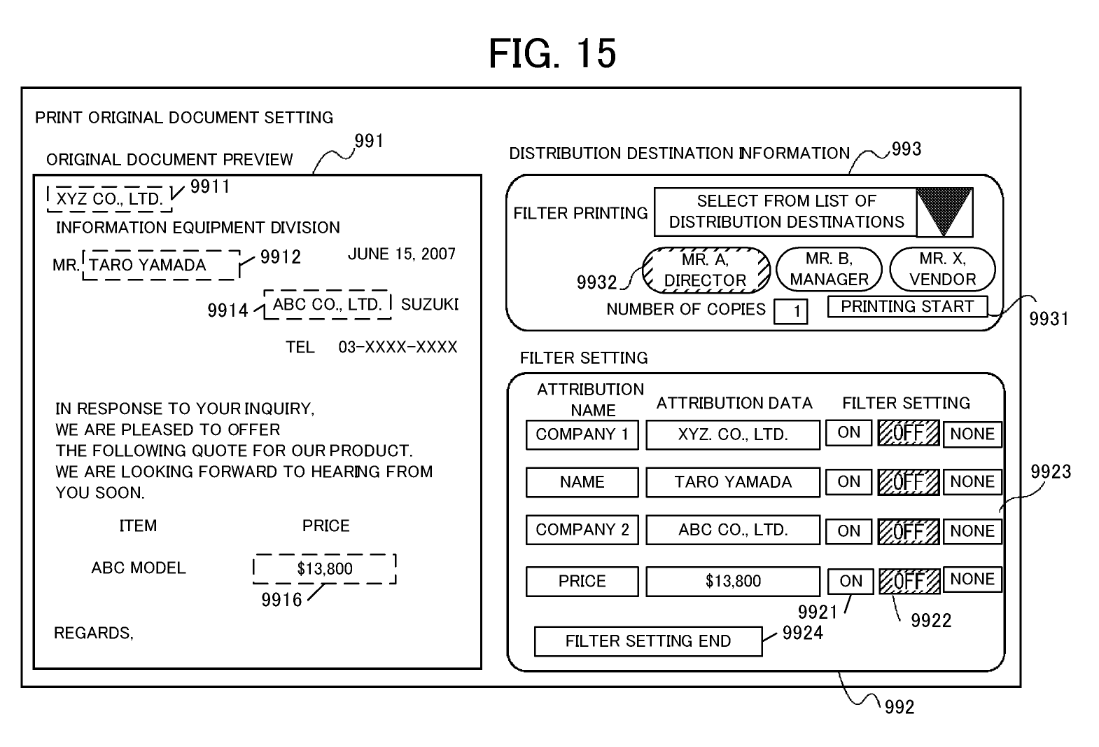

Now, the setting interface will be described in detail. FIG. 15 illustrates the setting interface in an initial state used to perform the filter settings of the document image data 95. For illustration purposes, in FIG. 15, a shading display is used in place of a solid black display.

As illustrated in FIG. 15, the setting interface includes an original document preview portion 991, a filter setting display portion 992, and a distribution destination setting portion 993.

The original document preview portion 991 displays a preview of the document image data 95 edited based on the filter setting data 98. In the original document preview portion 991, filter areas 9911, 9912, 9914, and 9916 indicating the areas on which the filtering process will be performed are displayed in dashed-lines. The filter areas 9911, 9912, 9914, and 9916 respectively correspond to the index areas 951, 952, 954, and 956. The filter areas are not displayed for the areas that correspond to the index areas 953 and 955. That is because the attribution names “DATE” and “TELEPHONE NUMBER” are set to “OFF” in the filter permission information 971.

The filter setting display portion 992 displays the attribution name and attribution data that correspond to each filter area. A filter validating button 9921, a filter invalidating button 9922, and a filter selection menu 9923 are provided with respect to each displayed attribution data.

The filter validating button 9921 is a button that validates the filter settings of the corresponding filter area. When the filter settings are valid, the filter validating button 9921 is displayed in black, and the filter selection menu 9923 becomes usable. The filter invalidating button 9922 is a button that invalidates the filter settings of the corresponding filter area. When the filter settings are invalid, the filter invalidating button 9922 is displayed in black, and the filtering process is not performed on the corresponding filter area. In the initial state, all of the filter invalidating buttons 9922 are displayed in black. That is because, when the screen data is created, all of the filter pattern information of the filter setting data 98 indicates “0”.

The filter selection menu 9923 displays, in a pull-down format, filter patterns that can be set on each filter area. The filter pattern set on each filter area is displayed in each title of the filter selection menu 9923.

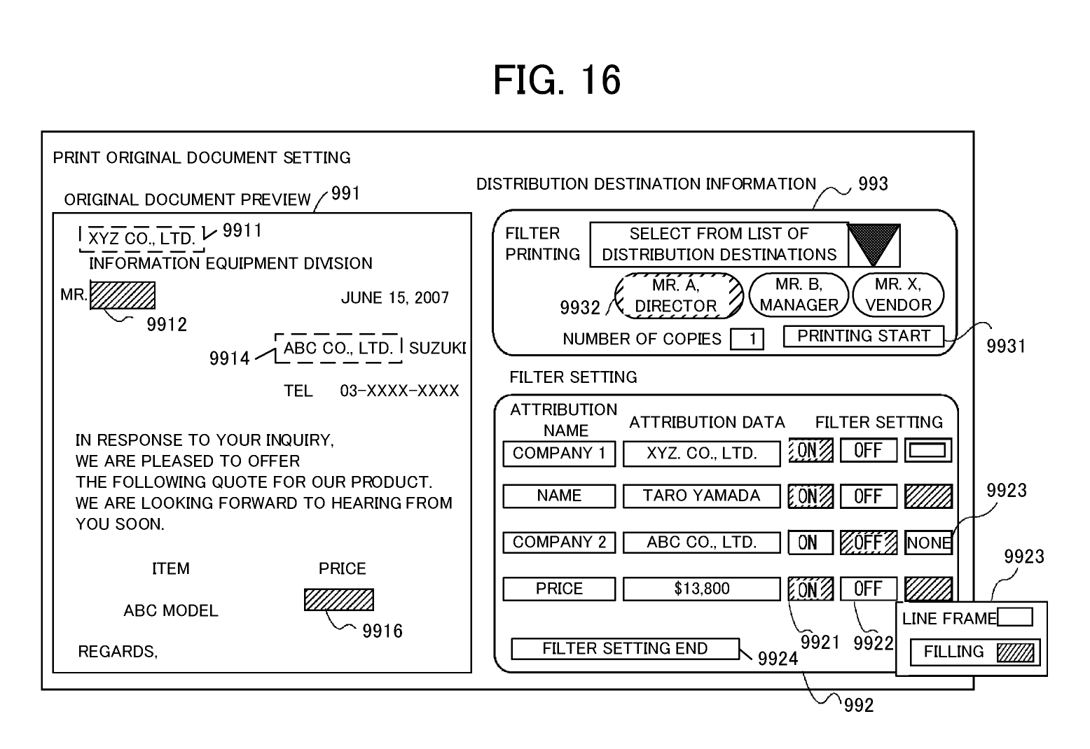

The filter patterns that can be set on each filter area are shown in the filter selection menu 9923 that corresponds to the attribution data “$13,800” of FIG. 16. The filter patterns that can be set on each filter area are “LINE FRAME” and “FILLING”. The filter patterns “LINE FRAME” and “FILLING” respectively correspond to the filter pattern information “1” and “2” that are recorded in the filter setting data 98. A detailed description of FIG. 16 will be made later.

A filter setting end button 9924 is arranged to notify the network MFP 901 of the completion of filter settings regarding the distribution destination displayed on the setting interface.

The distribution destination setting portion 993 displays a print start button 9931, a screen selection button 9932, and a pull-down menu arranged to add a distribution destination. The print start button 9931 is arranged to instruct the network MFP 901 to start printing. The screen selection button 9932 is arranged to call up the setting interface that corresponds to each distribution destination. The screen selection button 9932 displays a name of each distribution destination specified by the user. The name displayed on the screen selection button 9932 in black indicates the distribution destination on which the filter settings of the document image data 95 will be performed.

Now, the description of the operations of the network MFP 901 performed at the time of filter setting process is made again. The user checks the original document preview portion 991, and presses the filter validating button 9921 that corresponds to the filter area for which the filter settings are changed. By using the filter selection menu 9923, the user sets the filter pattern of the filter area for which the filter settings have been validated.

The PC 902 transmits, to the network MFP 901, the ID and filter pattern information that correspond to the filter area for which the filter settings have been changed. The filter setting unit 9113 updates the filter setting data 98 based on the received ID and filter pattern information. The screen data creating unit 9115 creates screen data based on the updated filter setting data 98, and transmits the created screen data to the PC 902. Thus, the setting interface reflecting (displaying) the change of the filter settings is displayed on the monitor 9021 of the PC 902. The user repeats the above-described operation with respect to the setting interface, and performs the filter settings of the document image data 95 that corresponds to each distribution destination.

When performing the filter settings of the document image data 95 with respect to another distribution destination, the user presses the filter setting end button 9924. In response to the instruction for the filter setting completion, the screen data creating unit 9115 transmits screen data of the distribution destination for which the filter settings have not been completed. The user may call up the setting interface that corresponds to each distribution destination by pressing the screen selection button 9932.

FIG. 16 illustrates the setting interface displayed after the filter settings of the document image data 95 are changed. The reference numerals of FIG. 16 correspond to those of FIG. 15. For illustration purposes, FIG. 16 uses a shading display in place of a solid black display. In the setting interface of FIG. 16, the filter pattern displayed in each title of the filter selection menu 9923 corresponds to a display state of each of the filter areas 9911, 9912, 9914, and 9916.

The screen data creating unit 9115 creates the original document preview portion 991 without directly editing the document image data 95. For example, the screen data creating unit 9115 can create the original document preview portion 991 by overlapping a rectangular graphical object having a black displaying color on the document image data 95.

As described above, when printing the document image data 95, the network MFP 901 sets the area on which the filtering process will be performed, with respect to each distribution destination, based on the index data 96 and the filter permission information 971. Therefore, the user can perform the filtering process of the document image data 95 only by setting the display state of the index area that is associated with the distribution destination.

An example has been described in which the user operates the PC 902 in order to print the document image data 95, however, the present invention is not limited to the above-described example. The user may directly operate the network MFP 901 to perform the filter settings of the document image data 95. In such a case, the setting interface of FIGS. 15 and 16 is displayed on the touch-screen display unit 9013.

An example has been described in which the network MFP 901 acquires the document image data 95 and the index data 96 from the file management server 903, however, the present invention is not limited to the above-described example. For example, the PC 902 may store the document image data 95 and the index data 96. In such a case, when the user operates the PC 902 in order to instruct the network MFP 901 for printing, the document image data 95 and the index data 96 are transmitted from the PC 902 to the network MFP 901.

An example of the highlighting process using the line frame and the filling process using the black color has been described, however, the present invention is not limited to the above-described example. For example, in the highlighting process, the display color may be inverted. Further, in the filling process, colors other than black may be used.

While the detailed description has been given above with respect to embodiments discussed, the present invention is not limited to these embodiments, and various modifications and variants, that fall within the true spirit and scope of the claimed invention, are possible.

What is claimed is:

1. An image editing apparatus arranged to edit an image data for transmitting to a transmission destination, comprising:
a storage unit arranged to store, along with the image data, an index data in which a character string extracted from the image data and an area information indicating an area that includes the character string are recorded as an index of the image data;
a management unit arranged to manage, in association with the transmission destination information, a determination information that is used to determine whether or not to apply filtering to the index;
a filter setting unit arranged to set a filter setting information with respect to a filtering-permitted index; and
an image editing unit arranged to edit the image data based on the area information and the filter setting information.

2. The image editing apparatus according to claim 1, wherein
the index records the character string and the area information in association with an identifier of the index, and
the determination information is information in which the identifier is associated with information indicating whether or not to apply filtering.

3. The image editing apparatus according to claim 2, wherein the filter setting information includes information regarding filter patterns to be applied to the index.

4. An image editing method arranged to edit an image data for transmitting to a transmission destination, comprising the steps of:
storing, along with the image data, an index data in which a character string extracted from the image data and an area information indicating an area that includes the character string are recorded as an index of the image data;
managing, in association with the transmission destination information, a determination information that is used to determine whether or not to apply filtering to the index;
setting a filter setting information with respect to a filtering-permitted index; and
editing the image data based on the area information and the filter setting information.

5. The image editing method according to claim 4, wherein
the index records the character string and the area information in association with an identifier of the index, and
the determination information is information in which the identifier is associated with information indicating whether or not to apply filtering.

6. The image editing method according to claim 5, wherein the filter setting information includes information regarding filter patterns to be applied to the index.

7. An image editing apparatus arranged to edit an image data for printing, comprising:
a storage unit arranged to store, along with the image data, an index data in which a character string extracted from the image data and an area information indicating an area that includes the character string are recorded as an index of the image data;
a management unit arranged to manage, in association with a distribution destination information of a printed document on which the image data is printed, a determination information that is used to determine whether or not to apply filtering to the index;
a filter setting unit arranged to set a filter setting information with respect to a filtering-permitted index; and
an image editing unit arranged to edit the image data based on the area information and the filter setting information.

8. The image editing apparatus according to claim 7, wherein
the index records the character string and the area information in association with an identifier of the index, and
the determination information is information in which the identifier is associated with information indicating whether or not to apply filtering.

9. The image editing apparatus according to claim 8, wherein the filter setting information includes information regarding filter patterns to be applied to the index.

10. An image editing method arranged to edit an image data for printing, comprising the steps of:
storing, along with the image data, an index data in which a character string extracted from the image data and an area information indicating an area that includes the character string are recorded as an index of the image data;
managing, in association with a distribution destination information of a printed document on which the image data is printed, a determination information that is used to determine whether or not to apply filtering to the index;
setting a filter setting information on a filtering-permitted index; and
editing the image data based on the area information and the filter setting information.

11. The image editing method according to claim 10, wherein
the index records the character string and the area information in association with an identifier of the index, and
the determination information is information in which the identifier is associated with information indicating whether or not to apply filtering.

12. The image editing method according to claim 11, wherein the filter setting information includes information regarding filter patterns to be applied to the index.
